(19) United States
(12) Patent Application Publication
(10) Pub. No.: US 2020/0400475 A1
(43) Pub. Date: Dec. 24, 2020

(54) Device and method for measuring the flow rate of a liquid

(71) Applicant: Université Grenoble Alpes, SAINT-MARTIN-D'HÉRES (FR)

(72) Inventors: Cyril PICARD, SAINT-EGREVE (FR); Elisabeth CHARLAIX, SAINT-JULIEN-EN-CHAMPSAUR (FR); Preeti SHARMA, GRENOBLE CEDEX 2 (FR)

(21) Appl. No.: 16/968,955

(22) PCT Filed: Feb. 25, 2019
(86) PCT No.: PCT/FR2019/050428

§ 371 Date: Aug. 19, 2020

(30) Foreign Application Priority Data
Mar. 1, 2018 (FR) 1851804

(51) Int. Cl. G01F 3/22

(52) U.S. Cl. CPC G01F 3/225; G01F 3/221

(57) ABSTRACT

The invention relates to a device and method for measuring the flow rate of a liquid flowing in a flow duct, from upstream to downstream, in which: a shutter member (4) is able to close/open said flow duct (3), a deformable membrane (5) obstructs an opening (6) made through the wall of said flow duct and situated upstream of said shutter member, and an electronic device (100) comprises a detection means (101) that detects deformations of said deformable membrane (5) and is able to deliver deformation signals, a means (112) that controls said shutter member (4), a means (112) that takes readings of the values of at least two deformation signals that are separated by a predetermined time period, established when the solenoid valve (4) is closed, and a calculation means that calculates a liquid volume depending on the read deformation signals and in order to calculate a flow rate depending on said calculated volume and the predetermined time period.

Embodiments of the present invention relate to the measurement of the flow rate of a liquid circulating in a duct.

Numerous methods exist for measuring the flow rate of a liquid.

An old method for measuring the flow rate of a liquid consists in collecting in a container the liquid released from a duct and in measuring the time required to collect a given volume of the liquid or in measuring the volume of liquid collected in a given duration.

Intrusive methods for continuously measuring the flow rate of a liquid consist in placing an obstacle in the flow of liquid and in measuring the displacement of the obstacle under the effect of the flow or in measuring the forces exerted on the obstacle by the flow of the liquid.

Non-intrusive methods for continuously measuring the flow rate of a liquid consist in measuring the variations in pressures brought about by a Venturi or a diaphragm through which the flow of the liquid passes.

Other methods for continuously measuring the flow rate of a liquid consist in measuring the thermal inertia of the liquid subjected locally to heating.

Other methods for continuously measuring the flow rate of a liquid are based on the use of the Doppler effect when tracers are present in the liquid or of fluorescence when fluorescent molecules are present in the liquid.

Other methods for continuously measuring the flow rate of a liquid, when it is electrically conductive, consist in measuring differences in potential that are brought about by the flow of the liquid.

The above methods can be adapted for the measurement of low flow rates but exhibit limited sensitivity.

The aim of the present invention is to propose a device for measuring the flow rate of a liquid that is capable in particular of measuring very low flow rates, with very low resolution, in particular flow rates less than one nanoliter per minute with precision of the order of one picoliter per minute.

A device for measuring the flow rate of a liquid circulating in a flow duct, from upstream to downstream, is proposed, comprising:

a shutoff member that is able to close/open said flow duct,

a deformable membrane that closes off an opening formed through the wall of said flow duct and situated upstream of said shutoff member, and

an electronic device, which comprises

a detection means for detecting deformations of said deformable membrane, and able to deliver deformation signals,

a means for controlling said shutoff member,

a means for taking readings of the values of at least two deformation signals, separated by a predetermined time interval, established when the solenoid valve is closed, and

a calculation means for calculating a liquid volume on the basis of the read deformation signals and for calculating a flow rate on the basis of said calculated volume and the predetermined time interval.

The electronic device may comprises a storage means for storing a chart of correspondence between the deformation signals and volumes, said storage means being connected to said calculation means.

The deformable membrane may be made of a piezoresistive material, in particular silicon.

Said detection means may comprise a Wheatstone bridge, the four legs of which include strain gauges, the part of the deformable membrane next to said opening in said flow duct being provided with these strain gauges.

The flow duct may comprise an upstream flow path, a downstream flow path and an intermediate chamber connecting said flow paths, said shutoff member being able to close the downstream flow path and the deformable membrane closing off an opening in the wall of the intermediate chamber.

The device may also comprise a second shutoff member that is able to close/open said flow duct, such that said deformable membrane is situated between said shutoff member and this second shutoff member, and a means for controlling this second shutoff member.

Also proposed is a system that comprises a source of a liquid and a member for utilizing the liquid, and comprising said device for measuring the flow rate, wherein said flow duct is connected to an outlet of the utilization member.

Also proposed is a method for measuring the flow rate of a liquid circulating in a flow duct, from upstream to downstream, provided with a shutoff member and a deformable membrane that closes off an opening formed through the wall of the flow duct and situated upstream of said shutoff means, comprising the following steps of:

putting the shutoff means in the closed state so as to close the flow duct,

detecting the deformation of the deformable membrane and taking readings of the values of at least two deformation signals representative of deformations of the deformable membrane, said signals being separated by a predetermined time interval, and

putting the shutoff means in the open state;

and comprising the following steps of:

calculating a volume of liquid on the basis of said values of said deformation signals,

calculating a flow rate of the liquid on the basis of said calculated volume and of said predetermined time interval.

The method may comprise the following step of: calculating said liquid volume on the basis of said values of said deformation signals and of a chart of correspondence between values of the deformation signal and volume values associated with deformations of the deformable membrane.

A device for measuring the flow rate of a liquid and an operating mode will now be described by way of exemplary embodiments illustrated in the drawing, in which:

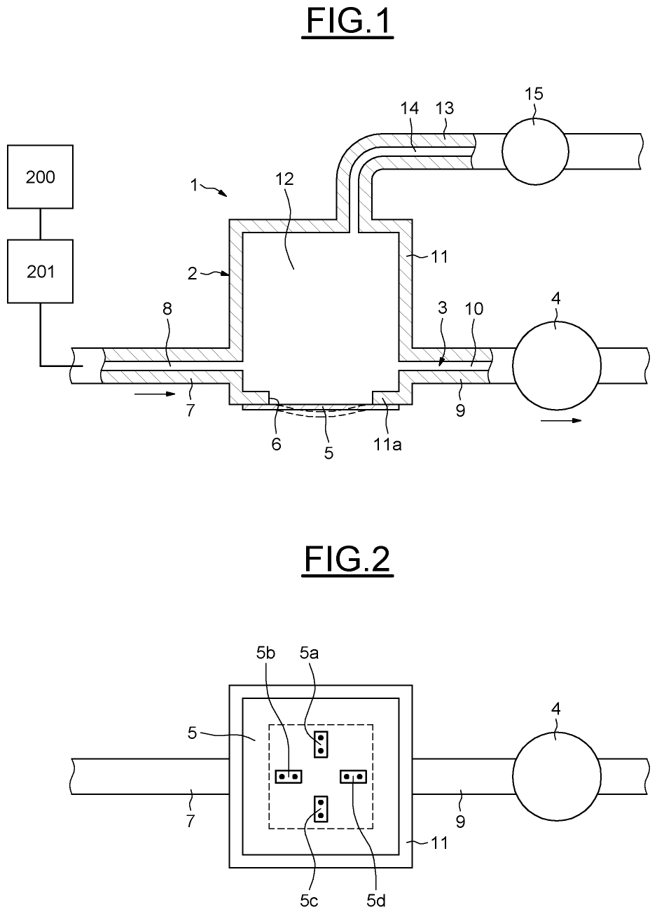

FIG. 1 shows a schematic cross-sectional view of a mechanical part of the measuring device;

FIG. 2 shows an outside view from below of the measuring device in FIG. 1;

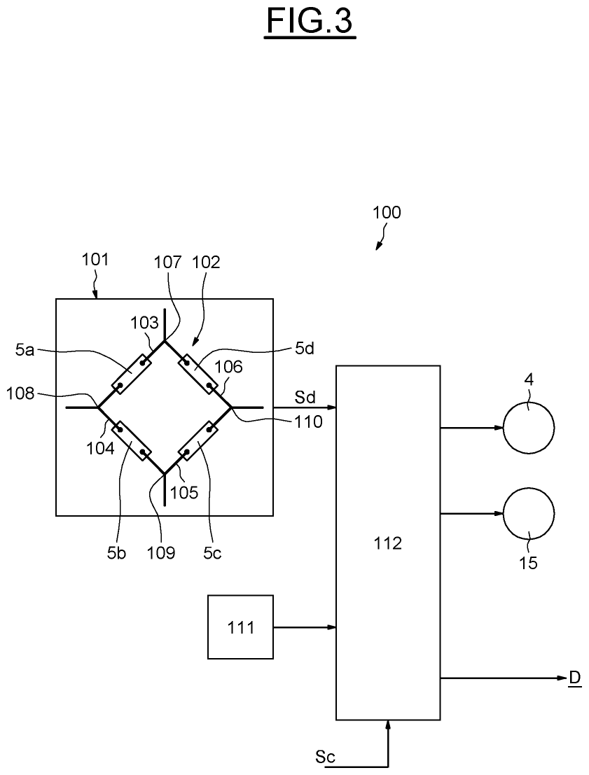

FIG. 3 shows an electronic diagram of the measuring device; and

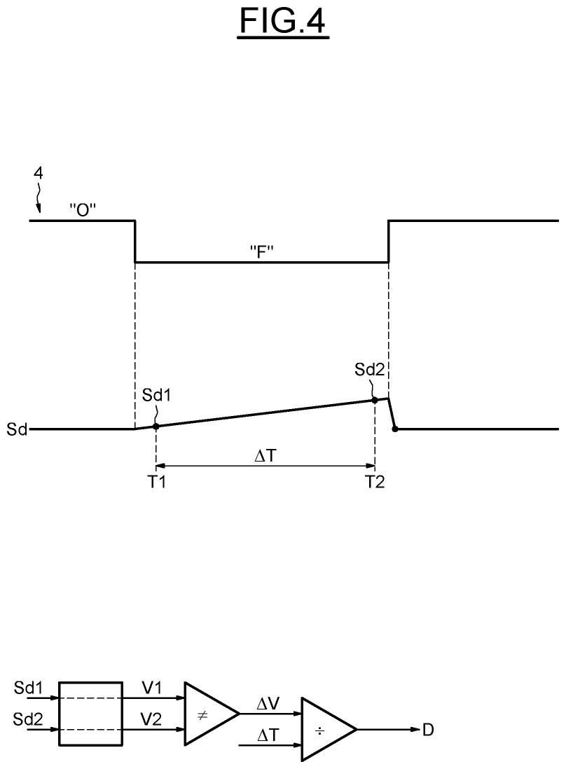

FIG. 4 shows operating diagrams of the measuring device.

FIGS. 1 and 2 illustrate a mechanical part of a device 1 for measuring flow rate, which comprises a duct 2 that delimits a flow channel 3 in which a liquid can flow, from upstream to downstream, that is to say in one direction.

The device 1 for measuring flow rate comprises a shutoff member 4, formed for example by a solenoid valve, which is able to close/open the flow duct 3.

The measuring device 1 comprises a deformable membrane 5 that seals off an opening 6 in the flow duct 3, formed upstream of the shutoff member 4.

The periphery of the deformable membrane 5 is fixed to a portion of the wall of the duct 2, around the opening 6, such that the liquid is in contact with a central portion of the inner face of the membrane 5, facing the side of the flow channel 3 and such that the pressure of the liquid in the duct is able to deform this central portion toward the outside.

In one embodiment, the duct 2 comprises an upstream tube 7 that forms an upstream flow path 8 via which the liquid arrives, a downstream tube 9 that forms a downstream flow path 10 via which the liquid is evacuated and is provided with the shutoff member 4, and an intermediate enclosure 11 that forms an intermediate chamber 12 situated between and connecting the upstream flow path and the downstream flow path.

A flat portion 1 la of the intermediate enclosure 11 is provided with the opening 6. The periphery of the deformable membrane 5 is fixed, for example by adhesive bonding, to this portion 11a. For example, the opening 6 and the deformable membrane 5 are square and have parallel sides.

The measuring device 1 comprises an electronic device 100, illustrated in FIG. 3, that is able to calculate the flow rate of a liquid circulating in the flow channel 3.

The electronic device 100 comprises a detection means 101 for detecting deformations of the deformable membrane 5, and able to deliver a deformation signal Sd on the basis of the deformation of the deformable membrane 5 under the effect of the pressure exerted by the liquid.

In one alternative embodiment, the detection means 101 comprises a Wheatstone bridge 102, the four legs 103, 104, 105 and 106 of which include strain gauges formed by strips 5a, 5b, 5c and 5d, made of a piezoresistive material, which are provided on the outer face of the part of the deformable membrane 5 next to the opening 6. Spaced-apart pairs of electrical connection points 103, 104, 105, 106 of the strips 5a, 5b, 5c and 5d are respectively connected to the vertices 107, 108, 109 and 110 of the Wheatstone bridge 102 by electrical connection wires.

Advantageously, for the one part, the strips 5a and 5c and the electrical connection points of these strips 5a and 5c are situated on a median of the deformable membrane 5 and symmetrically with respect to the center of the deformable membrane 5 and, for the other part, the strips 5b and 5d and the electrical connection points of these strips 5b and 5d are situated on either side of the other median of the deformable membrane 5 and symmetrically with respect to the center of the deformable membrane. The term “median” is understood to mean a line that extends perpendicularly to the two opposite and parallel sides of the deformable membrane 5 and passes through the middle of these sides.

The strips 5a, 5b, 5c and 5d are a piezoresistive material, that is to say a material of which the electrical resistance varies depending on a mechanical stress that deforms it. For example, the strips 5a, 5b, 5c and 5d are metallic, in particular based on silicon. For example, the deformable membrane 5 is metallic, in particular based on silicon. In particular, the strips 5a, 5b, 5c and 5d, which are electrically conductive, are produced by placement on the deformable membrane 5, which is not electrically conductive, or on a dielectric layer of the deformable membrane 5.

The signal Sd is then formed by the unbalance voltage of the Wheatstone bridge 102.

The electronic device 100 comprises a memory 111 in which a chart, or calculation table, of correspondence between values of the deformation signal Sd output by the detection means 101 and volume V values associated with deformations of the deformable membrane 5 has been pre-recorded.

This chart is the result of calibration measurements carried out for example in the following way.

A liquid is made to circulate in the flow channel 3 so as to completely fill and degas the intermediate chamber 12. To this end, the intermediate enclosure 11 can be equipped, optionally, with a vent tube 13 that forms a venting flow path 14 and is equipped with a solenoid vent valve 15.

The solenoid valve 4 is closed so as to close the downstream flow path 10 and the solenoid valve 15 is closed so as to close the venting flow path 14.

The liquid is placed under atmospheric pressure. The deformable membrane 5 is then in what is known as a reference position, in which the deformable membrane 5 is generally flat.

Next, determined additional quantities of liquid are introduced successively into the intermediate chamber 12 via the upstream flow path 8, successively bringing about corresponding outward deformations of the deformable membrane 5 under the effect of the pressure of the liquid, and the corresponding values of the signal Sd are read.

In one alternative embodiment of the calibration measurements, a liquid is made to circulate in the flow channel 3 at given variable flow rates, measured by suitable means, and each time the corresponding values of the deformation signal Sd output by the detection means 101 are read, so as to establish and save the corresponding chart in the memory 111.

The deformable membrane 5 does not disrupt the inlet of the liquid into the intermediate chamber 12.

Illustrated by way of dashed lines in FIG. 1 is a deformation of the part of the deformable membrane 5 situated next to the opening 6. As seen from the inside of the chamber 12, the shape of this deformation is concave and resembles a concave dome, the periphery of which is convex.

Advantageously, in a first region of deformations of the deformable membrane 5, from the abovementioned reference position thereof, the values of the signal Sd lie approximately on a straight line, such that the chart saved in the memory 111 can be determined as being such a straight line.

The electronic circuit 100 comprises a programmed microcontroller 112, which is connected to the detection means 101, to the memory 111, to the solenoid valve 4 and, optionally, to the solenoid valve 15.

Advantageously, the programmed microcontroller 112 can be employed to create the abovementioned chart.

The operation of the measuring device 1 will now be described with reference in particular to FIG. 4.

With the solenoid valve 4 in the open state “O” and the solenoid valve 15 in the closed state, a liquid from a source circulates in the flow channel 3 from upstream to downstream. The intermediate chamber 12 is filled with the liquid that passes through it.

In order to determine the flow rate of the liquid, the microcontroller 112, having received a control order Sc, carries out the following steps, as illustrated in FIG. 4.

The microcontroller 112 commands the closure of the solenoid valve 4 in order to close off the downstream flow path 10 and to prevent the liquid from flowing downstream of the solenoid valve 4.

With the solenoid valve 4 in the closed state “F”, the liquid continues to arrive in the chamber 12 and causes a continuous deformation of the deformable membrane 5.

At a time T1, the microcontroller 112 reads the value Sd1 of the signal Sd. This time T1 may be just at the moment when the solenoid valve 4 is put into the closed state or shortly afterwards.

Following a preprogrammed, predetermined period of time ΔT, the microcontroller 112 reads, at a time T2, the value Sd2 of the signal Sd.

Thus, the readings of the values Sd1 and Sd2 are separated by a time interval ΔT established when the solenoid valve 4 is closed.

When the value of the signal Sd2 is read, the microcontroller 112 takes from the pre-recorded chart the value of the volume V1 corresponding to the value of the signal Sd1 and the value of the volume V2 corresponding to the value of the signal Sd2 and calculates the value of the difference ΔV between the values of the volumes V2 and V1.

Next, the microcontroller 112 calculates the value of the ratio D between the value of the difference ΔV and the value of the predetermined period of time ΔT and outputs the value of the ratio D, this value constituting the desired value of the flow rate of the liquid arriving via the upstream flow path 8.

With the value of the signal Sd2 having been read, the microcontroller 112 commands the opening of the solenoid valve 4 in order to reestablish the circulation of the liquid in the flow channel 3.

In parallel and optionally, the microcontroller 112 commands the solenoid valve 15 to open for a short period so as to facilitate the evacuation of excess liquid in the chamber 12 resulting from the measurement.

Advantageously, the predetermined period of time ΔT is fixed on the basis of a presumed flow rate of the liquid, such that the values Sd1 and Sd2 lie on a straight line in the chart, as defined above.

The measuring device 1 is particularly suitable for taking measurements of very low flow rates, which may be of the order of one nanoliter per minute, with a precision of the order of a few picoliters, the period of time ΔT between the readings of the values Sd1 and Sd2 being of the order of a few minutes.

In one exemplary embodiment, the flow paths 8 and 10 can have cross-sectional areas of around twenty-five hundredths of a millimeter squared (0.25 mm²), the intermediate chamber 12 can be parallelepipedal and can have sides of around three millimeters (3 mm) and a height of around fourteen millimeters (14 mm) (the deformable membrane 5 being placed at one end of the intermediate chamber 12), the deformable membrane 5 can have sides of around two and a half millimeters (2.5 mm), the deformable membrane 5 can have a thickness of around thirteen microns (3 micrometers).

The wall 11 of the intermediate chamber 12 is designed so as to reduce the influence of the outside temperature. For example, the wall 11 of the intermediate chamber 12 can be equipped with a means for regulating the temperature thereof.

In one particular use example, illustrated in FIG. 1, the device 1 for measuring flow rate can be included in a system that comprises an upstream source 200 of liquid and a member 201 for utilizing the liquid from the upstream source 200, the measuring device 1 being connected to an outlet of the utilization member 200 such that the liquid is evacuated from the utilization member 201 by passing through the flow channel 3 of the measuring device 1 from upstream to downstream.

For example, the source 200 is a reservoir of several milliliters of liquid pressurized by a pressurized gas and the utilization member 201 is a nanofluidic circuit having a channel with a length of several microns and with a circular cross section with a diameter of around one hundred nanometers (100 nm).

In one alternative embodiment, the detection means 101 could comprise an optical detector that detects the displacements of the central point of the deformable membrane 5.

In one alternative embodiment, the device 1 for measuring flow rate could comprise a second solenoid shutoff valve that is able to close/open the flow duct 3, placed on the tube 7, so as to be able to measure the flow rate of a liquid circulating in the channel 3, in the other direction to the direction mentioned above. In this case, the channel 10 would become an upstream channel and the channel 7 would become a downstream channel. The flow rate of the liquid would be measured in an equivalent manner to the one described above, the microcontroller 112 this time activating this second solenoid valve.

1. A device for measuring the flow rate of a liquid circulating in a flow duct, from upstream to downstream, comprising:
a shutoff member (4) that is able to close/open said flow duct (3),
a deformable membrane (5) that closes off an opening (6) formed through the wall of said flow duct and situated upstream of said shutoff member, and
an electronic device (100), characterized in that it comprises
a detection means (101) for detecting deformations of said deformable membrane (5), and able to deliver deformation signals (Sd),
a means (112) for controlling said shutoff member (4),
a means (112) for taking readings of the values (Sd1, Sd2) of at least two deformation signals, separated by a predetermined time interval (ΔT), established when the solenoid valve (4) is closed, and
a calculation means (112) for calculating a liquid volume (V) on the basis of the read deformation signals (Sd1, Sd2) and for calculating a flow rate (D) on the basis of said calculated volume (V) and the predetermined time interval (ΔT).

2. The device as claimed in claim 1, wherein the electronic device (100) comprises a storage means (111) for storing a chart of correspondence between the deformation signals and volumes, said storage means (111) being connected to said calculation means (112).

3. The device as claimed in either of claims 1 and 2, wherein the deformable membrane (5) is made of a piezoresistive material, in particular silicon.

4. The device as claimed in any one of the preceding claims, wherein said detection means (101) comprises a Wheatstone bridge (102), the four legs (103, 104, 105 and 106) of which include strain gauges (5a, 5b, 5c and 5d), the part of the deformable membrane (5) next to said opening (6) in said flow duct (3) being provided with these strain gauges.

5. The device as claimed in any one of the preceding claims, wherein the flow duct (3) comprises an upstream flow path (8), a downstream flow path (10) and an intermediate chamber (12) connecting said flow paths, said shutoff member (4) being able to close the downstream flow path (10) and the deformable membrane (5) closing off an opening (6) in the wall of the intermediate chamber (12).

6. The device as claimed in any one of the preceding claims, comprising a second shutoff member that is able to close/open said flow duct (3), such that said deformable membrane (5) is situated between said shutoff member and this second shutoff member, and comprising a means for controlling this second shutoff member.

7. A system comprising a source (200) of a liquid and a member (201) for utilizing the liquid, and comprising a device for measuring the flow rate as claimed in any one of the preceding claims, wherein said flow duct (3) is connected to an outlet of the utilization member.

8. A method for measuring the flow rate of a liquid circulating in a flow duct (3), from upstream to downstream, provided with a shutoff member (4) and a deformable membrane (5) that closes off an opening (6) formed through the wall of the flow duct and situated upstream of said shutoff means, characterized in that it comprises the following steps of:
putting the shutoff means in the closed state so as to close the flow duct,
detecting the deformation of the deformable membrane (5) and taking readings of the values (Sd1, Sd2) of at least two deformation signals representative of deformations of the deformable membrane (5), said signals being separated by a predetermined time interval (ΔT), and
putting the shutoff means in the open state;
and comprising the following step of:
calculating a volume of liquid on the basis of said values (Sd1, Sd2) of said deformation signals,
calculating a flow rate of the liquid on the basis of said calculated volume and of said predetermined time interval (ΔT).

9. The method as claimed in claim 8, comprising the following step of:
calculating said liquid volume (V) on the basis of said values (Sd1, Sd2) of said deformation signals and of a chart of correspondence between values of the deformation signal (Sd) and volume (V) values associated with deformations of the deformable membrane (5).
